(19) United States
(12) Patent Application Publication
(10) Pub. No.: US 2005/0278707 A1
(43) Pub. Date: Dec. 15, 2005

(54) Method and system providing virtual resource usage information

(75) Inventor: James D. Guilford, Northborough, MA (US)

Correspondence Address: Daly, Crowley & Mofford, LLP;PortfolioIP, P.O. Box 52050, Minneapolis, MN, 55402, US

(73) Assignee: Intel Corporation

(21) Appl. No.: 10/864,666

(22) Filed: Jun. 9, 2004

(51) Int. Cl. G06F 9/44

(52) U.S. Cl. 717/130

(57) ABSTRACT

A method and system to provide virtual resource usage information for assembler programs. In one embodiment, a graphical user interface displays virtual resource usage for portions of an assembler program.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, assembly code is used to program hardware devices, such as processors. The target hardware has certain resources, such as registers, that the programmer uses when developing a program. Some known assemblers typically require a programmer to directly reference particular resources, e.g., MOV R0, value, where R0 represents a physical register in the target device.

Other assemblers, such as the Intel IXP2400 and IXP2800 Network Processor Assembler, enable a user to develop programs using virtual hardware references. That is, a programmer uses a virtual name for a register or other resource. The assembler attempts to map virtual resources to physical resources in the target hardware. While the ability to use virtual names provides certain advantages, such as ease of use, a programmer may develop an assembler code program requiring more registers than are available in the target hardware. In this situation, the assembler cannot successfully map the virtual registers to physical registers.

### BRIEF DESCRIPTION OF THE DRAWINGS

The exemplary embodiments will be more fully understood from the following detailed description taken in conjunction with the accompanying drawings, in which:

FIG. 1 is a block diagram of a processor having processing elements that support multiple threads of execution;

FIG. 2 is a block diagram of an exemplary processing element (PE) that runs microcode;

FIG. 3 is a depiction of some local Control and Status Registers (CSRs) of the PE of FIG. 2;

FIG. 4 is a schematic depiction of an exemplary development/debugging system that can be used to develop/debug microcode for the PE shown in FIG. 2;

FIG. 5 is a block diagram illustrating the various components of the development/debugger system of FIG. 4;

FIG. 6 is a graphical user interface showing virtual register usage information;

FIG. 7 is a flow diagram showing exemplary processing to provide virtual register usage information to a user;

FIG. 8 is a flow diagram showing exemplary processing to implement a graphical user interface providing virtual register usage information; and

FIG. 9 is a graphical representation of a flow graph;

FIG. 10 is a flow diagram showing an exemplary process to generate a flow graph;

FIG. 10A is a graphical representation of a flow graph;

FIG. 10B is a flow diagram showing further details of a process to generate a flow graph;

FIG. 11 is a schematic representation of an exemplary computer system suited to provide virtual register usage information; and

FIG. 12 is a diagram showing a network forwarding device.

### DETAILED DESCRIPTION

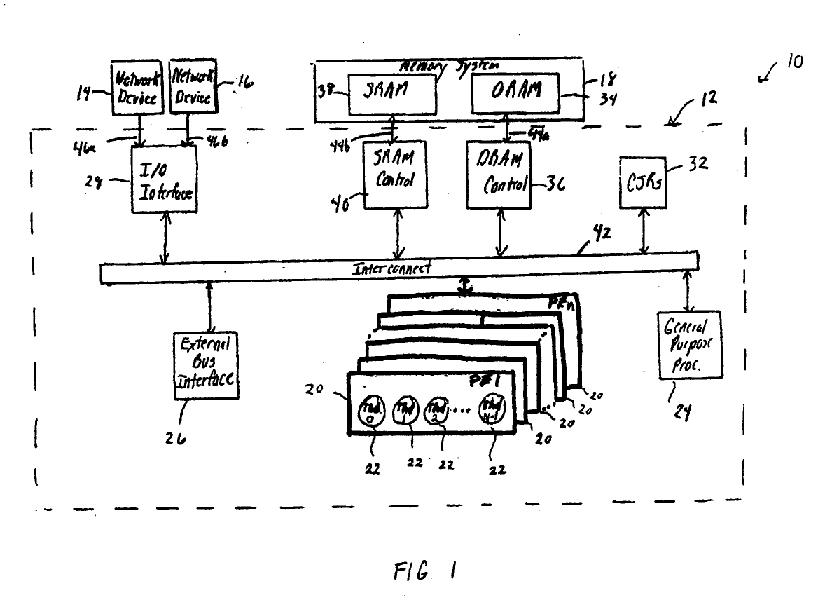

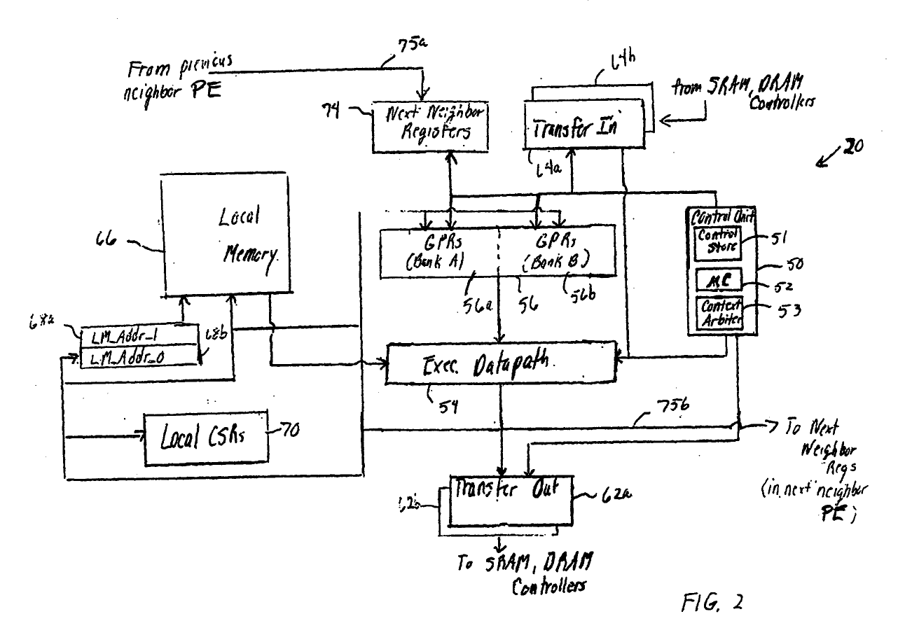

FIG. 1 shows a system 10 includes a processor 12 that can contain microcode developed by a programmer using an assembler providing virtual register usage information, as described further below. In general, a programmer generates an assembler program containing references to virtual hardware resources, such as registers, for which the assembler attempts to allocate to physical resources in the target hardware, (e.g., the processing elements 20 of FIG. 2). The assembler processes the program code and provides live register usage information, such as the number of registers required at a given microcode instruction, to the programmer. By providing a programmer with virtual register usage information, the programmer can quickly identify areas of code that require more live registers than are available on the target hardware.

The processor 12is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, storing buffer descriptors and free buffer lists, and so forth.

The devices 14, 16 can be any network devices capable of transmitting and/or receiving network traffic data, such as framing/MAC devices, e.g., for connecting to 10/100BaseT Ethernet, Gigabit Ethernet, ATM or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

Referring to FIG. 2, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

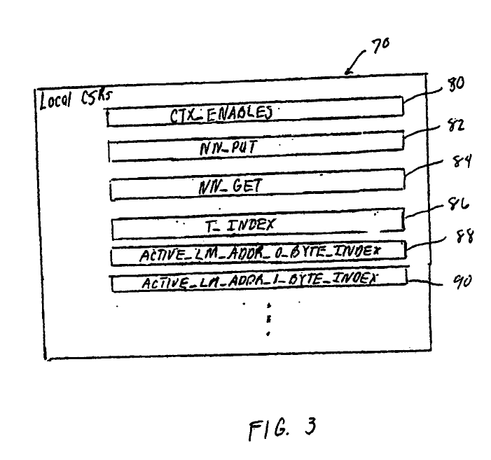

Generally, the local CSRs 70 are used to maintain context state information and inter-thread signaling information. Referring to FIG. 3, registers in the local CSRs 70 may include the following: CTX_ENABLES 80; NN_PUT 82; NN_GET 84; T_INDEX 86; ACTIVE_LM ADDR_{—}0_BYTE_INDEX 88; and ACTIVE_LM ADDR_{—}1_BYTE_INDEX 90. The CTX_ENABLES register 80 specifies, among other information, the number of contexts in use (which determines GPR and transfer register allocation) and which contexts are enabled. It also controls how NN mode, that is, how the NN registers in the PE are written (NN_MODE=‘0’ meaning that the NN registers are written by a previous neighbor PE, NN_MODE=‘1’ meaning the NN registers are written from the current PE to itself). The NN_PUT register 82 contains the “put” pointer used to specify the register number of the NN register that is written using indexing. The NN_GET register 84 contains the “get” pointer used to specify the register number of the NN register that is read when using indexing. The T_INDEX register 86 provides a pointer to the register number of the transfer register (that is, the S_TRANSFER register 62a or D_TRANSFER register 62b) that is accessed via indexed mode, which is specified in the source and destination fields of the instruction. The ACTIVE_LM ADDR_{—}0_BYTE_INDEX 88 and ACTIVE_LM ADDR_{—}1_BYTE_INDEX 90 provide pointers to the number of the location in local memory that is read or written. Reading and writing the ACTIVE_LM_ADDR_x_BYTE_INDEX register reads and writes both the corresponding LM_ADDR_x register and BYTE INDEX registers (also in the local CSRs).

In the illustrated embodiment, the GPR, transfer and NN registers are provided in banks of 128 registers. The hardware allocates an equal portion of the total register set to each PE thread. The 256 GPRs per-PE can be accessed in thread-local (relative) or absolute mode. In relative mode, each thread accesses a unique set of GPRs (e.g., a set of 16 registers in each bank if the PE is configured for 8 threads). In absolute mode, a GPR is accessible by any thread on the PE. The mode that is used is determined at compile (or assembly) time by the programmer. The transfer registers, like the GPRs, can be assessed in relative mode or in absolute-mode. If accessed globally in absolute mode, they are accessed indirectly through an index register, the T_INDEX register. The T_INDEX is loaded with the transfer register number to access.

As discussed earlier, the NN registers can be used in one or two modes, the “neighbor” and “self” modes (configured using the NN_MODE bit in the CTX_ENABLES CSR). The “neighbor” mode makes data written to the NN registers available in the NN registers of a next (adjacent) downstream PE. In the “self” mode, the NN registers are used as extra GPRs. That is, data written into the NN registers is read back by the same PE. The NN_GET and NN_PUT registers allow the code to treat the NN registers as a queue when they are configured in the “neighbor” mode. The NN_GET and NN_PUT CSRs can be used as the consumer and producer indexes or pointers into the array of NN registers.

At any give time, each of the threads (or contexts) of a given PE is in one of four states: inactive; executing; ready and sleep. At most one thread can be in the executing state at a time. A thread on a multi-threaded processor such as PE 20 can issue an instruction and then swap out, allowing another thread within the same PE to run. While one thread is waiting for data, or some operation to complete, another thread is allowed to run and complete useful work. When the instruction is complete, the thread that issued it is signaled, which causes that thread to be put in the ready state when it receives the signal. Context switching occurs only when an executing thread explicitly gives up control. The thread that has transitioned to the sleep state after executing and is waiting for a signal is, for all practical purposes, temporarily disabled (for arbitration) until the signal is received.

While illustrative target hardware is shown and described in some detail, it is understood that the exemplary embodiments herein are applicable to assemblers supporting a wide variety of target hardware, processors, architectures, devices, development/debug systems, and the like.

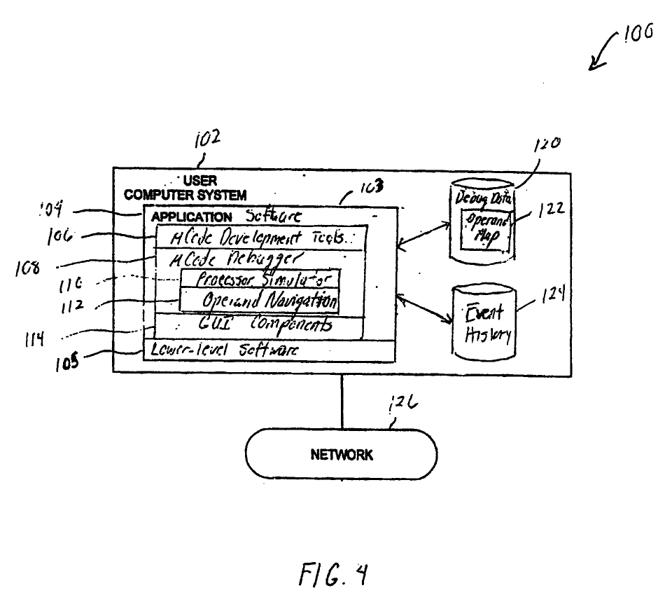

FIG. 4 shows an integrated development/debugger system environment 100 that includes a user computer system 102. The computer system 102 is configured to develop/process/debug microcode that is intended to execute on a processing element. In one embodiment, the processing element is the PE 20, which may operate in conjunction with other PEs 20, as shown in FIGS. 1-2.

Software 103 includes both upper-level application software 104 and lower-level software (such as an operating system or “OS”) 105. The application software 104 includes microcode development tools 106 (for example, in the example of processor 12, a compiler and/or assembler, and a linker, which takes the compiler or assembler output on a per-PE basis and generates an image file for all specified PEs). The application software 104 further includes a source level microcode debugger 108, which include a processor simulator 110 (to simulate the hardware features of processor 12) and an Operand Navigation mechanism 112. Also include in the application software 104 are GUI components 114, some of which support the Operand Navigation mechanism 112. The Operand Navigation 112 can be used to trace instructions.

Still referring to FIG. 4, the system 102 also includes several databases. The databases include debug data 120, which is “static” (as it is produced by the compiler/linker or assembler/linker at build time) and includes an Operand Map 122, and an event history 124. The event history stores historical information (such as register values at different cycle times) that is generated over time during simulation. The system 102 may be operated in standalone mode or may be coupled to a network 126 (as shown).

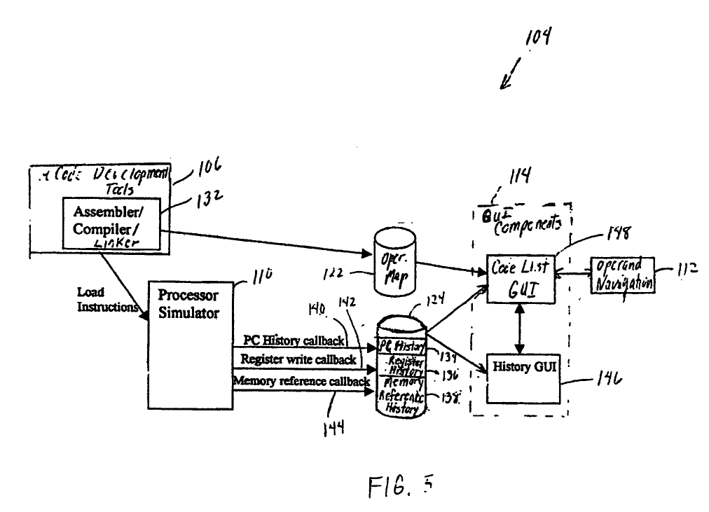

FIG. 5 shows a more detailed view of the various components of the application software 104 for the debugger/simulator system of FIG. 4. They include an assembler and/or compiler, as well as linker 132; the processor simulator 110; the Event History 124; the (Instruction) Operation Map 126; GUI components 114; and the Operand Navigation process 112. The Event History 124 includes a Thread (Context)/PC History 134, a Register History 136 and a Memory Reference History 138. These histories, as well as the Operand Map 122, exist for every PE 20 in the processor 12.

The assembler and/or compiler produce the Operand Map 122 and, along with a linker, provide the microcode instructions to the processor simulator 110 for simulation. During simulation, the processor simulator 110 provides event notifications in the form of callbacks to the Event History 124. The callbacks include a PC History callback 140, a register write callback 142 and a memory reference callback 144. In response to the callbacks, that is, for each time event, the processor simulator can be queried for PE state information updates to be added to the Event History. The PE state information includes register and memory values, as well as PC values. Other information may be included as well.

Collectively, the databases of the Event History 124 and the Operand Map 122 provide enough information for the Operand Navigation 112 to follow register source-destination dependencies backward and forward through the PE microcode.

In an exemplary embodiment, an assembler, which can form part of a development tool such as development system 102, provides a programmer with virtual register usage information. The programmer develops code in assembly language that references virtual registers, which are mapped by the assembler to physical registers in the target hardware. The programmer has limited available resources, e.g., registers, in the target hardware. If the numbers of registers required by the program at any given time exceeds the number of available physical registers, then the program may not be successfully implemented in the target hardware. More particularly, the assembler attempts to map the virtual registers in the program source code to physical registers in the target hardware, while preventing two registers that conflict from being stored in the same physical register. Two virtual registers conflict if either is assigned a new value while the other contains a live value. If the assembler cannot successfully map the virtual registers, then the assembly fails.

In general, the assembler/development system provides information regarding the number of so-called live registers at a given time and/or instruction. In one particular embodiment, for each microword or instruction, the number of live registers is determined. As used herein, the term “live register” refers in general to a register during the time that the register contains a useful value, that is the time between the last time a value is assigned to a register until the last time that value is used as the source of an operation, as described more fully below.

For example, a register VREG0 would be live from a first pseudo instruction VREG0=VAL1 to a second (and last) pseudo instruction VREG1=VREG0. It is understood that the assembler will search for the last time VREG0 is the source for an operation after the assignment operation. With this arrangement, programmers can be presented with information regarding register usage in order that they may easily and appropriately modify code to reduce register usage as necessary. Programmers can readily detect and re-code program segments in which the number of available registers is exceeded.

Signals are handled in a similar manner as registers. Signals are used by target hardware to schedule threads. In particular, when a thread issues an I/O operation, it specifies a signal number to use. When the I/O unit performs the operation, it sends the specified signal to the microengine so as to wake up the thread which is then eligible to run again.

Signals are managed by the assembler in a manner that is substantially similar as registers. The target hardware contains a given number of signals, e.g., 15 signals (1, . . ,15). Programmers use names for virtual signals to represent signals. The assembler computes live ranges and interference graphs for the virtual signals and allocates each virtual signal (i.e. name) to a physical signal (e.g.,. signal number 1, . . , 15).

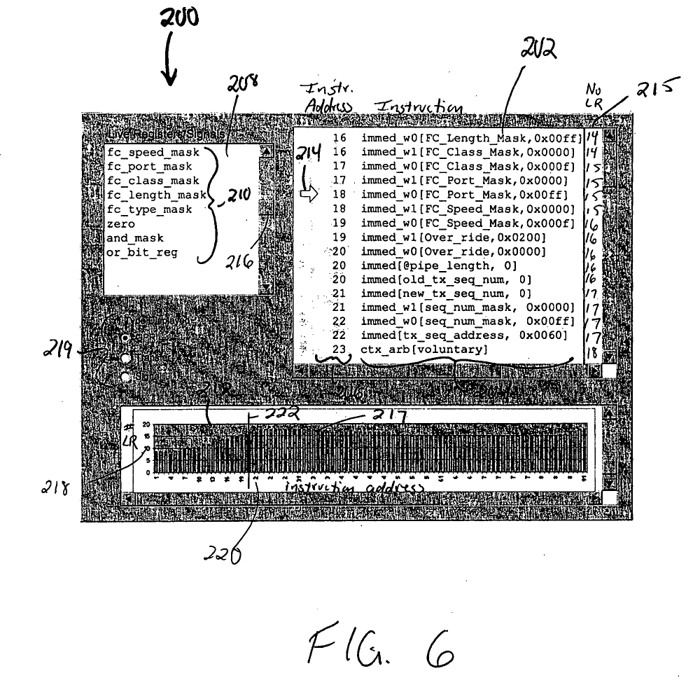

FIG. 6 shows an exemplary embodiment of a graphical user interface (GUI) 200 providing virtual register usage information to a user. In one embodiment, the GUI 200 includes a first region 202 to display instructions 204 along with instruction addresses 206, a second region 208 to display the names 210 of live virtual registers, and a third region 212 to display a graph showing register usage levels. The third region 212 can be referred to as a register pressure graph. It is understood that the GUI 200 can display any number of the first, second and third regions 202, 208, 212 at any one time. In one embodiment, the user can select which of the first, second and third regions should be displayed.

In one embodiment, the first region 202 includes a list of exemplary instructions 204 and instruction addresses 206. The first region 202 can also include an indicator 214 selecting a particular one of the microwords and a count 215 of the number of live registers for each microword. The second region 208 displays a list of the currently live registers/signals for the indicated microword. A scroll bar 216 can enable a user to view a desired portion of the listed live virtual registers 210. The third region 212 shows a graph 217 of the number of live registers 218 versus instruction address 220. The level of live virtual registers 218 can correspond to the count 215 of the number of live registers in the first region 202.

The GUI 200 can also include a register type selection area 219. In an exemplary embodiment, the user can select to display any of GPR, transfer, and signal registers. It is understood that the register types can be determined by the target hardware.

In one embodiment, the selected instruction, marked by the indicator 214 in the first region 202, determines the live registers 210 displayed in the second region 208 and the instruction address/live register graph 217 in the third region 212. A cursor 222 in the third region 212 corresponds to the instruction address selected by the indicator 214 in the first region 202. The live registers 210 displayed in the second region 208 can correspond to the live registers of the instructions shown in the first region 202.

In an exemplary embodiment, each of the displays in the first, second and third regions 202, 208, 212 can be updated to reflect a user selection in any of the regions. For example, in the first region 202 the user may move the indicator 214. The information displayed in the second and third regions 208, 212 would change to reflect the instructions now displayed in the first region 202. Similarly, if the user moves the cursor 222 in the third region 212, the information in the first and second regions 208, 212 will be updated to reflect the change in cursor position to achieve synchronization of the information shown in each of the regions. That is, the instructions corresponding to the new cursor position will be shown in the first region 202 and the indicator 214 moved to correspond to the cursor 222. The displayed listing of live registers in the second region 208 can also be updated.

In another embodiment, an assembler processes program code and generates a file that contains live register information. The assembler determines virtual register usage information and dumps the register lifetime information into an output file, which can be referred to as the LRI file. The LRI file can be produced even when register mapping fails, i.e., the code does not successfully assemble so that microcode is not produced. The LRI file can include raw source (post preprocessor) along with embedded “directives” giving the registers live at each instruction.

In one particular embodiment, the directives include:

.% live_regs cnt addr gpr sr_xfer sw_xfer dr_xfer dw_xfer sig

which gives the count of live registers of the different types for the associated microword, where the “addr” field gives the corresponding microword address (if the source file assembles successfully and the optimizer is not used). The next six fields then give the counts in terms of relative registers (gpr, SRAM-read transfer registers, SRAM-write transfer registers, DRAM-read-transfer registers, DRAM-write-transfer registers, and signal registers).

A comment line, such as:

;% live_regs cnt addr gpr $R $W $$R $$W sig

can indicate what the different numbers from the “.% live_regs cnt” directive above mean. This comment line can be useful, for example, when the counts are imported into a spreadsheet application.

A line, such as:

.% live_regs type addr name1 name2 name3 . . .

can provide the list of live registers, where the type field contains the same labels as from the “;% live_regs cnt” line above. The “addr” field is as described above for “;% live_regs cnt”. The names correspond to the names of the live registers.

The LRI file can be filtered, such as by “.% live_regs cnt”, and loaded into a spread sheet. A plot of the live register counts can then be plotted in the spreadsheet application.

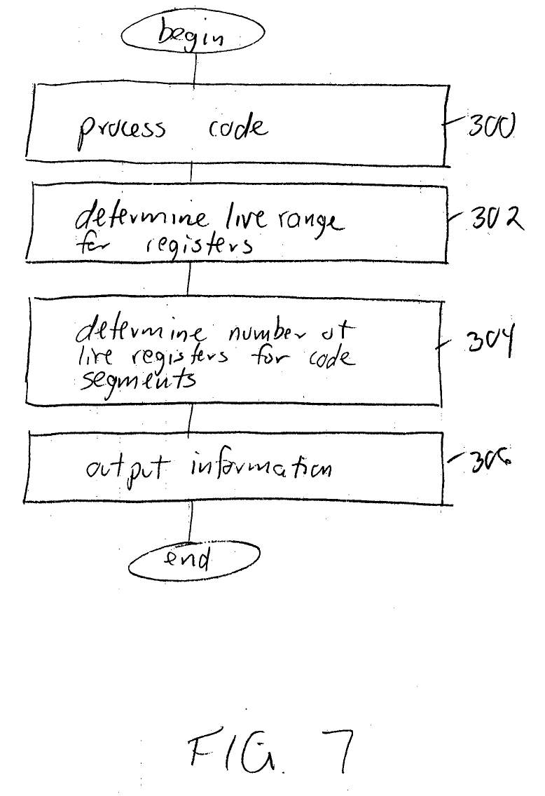

FIG. 7 is a flow diagram showing an exemplary implementation providing virtual register usage information. In processing block 300, an assembler processes an assembly program. The assembler determines live ranges for the various virtual registers in block 302. For each program segment, such as each microword, the number of live virtual registers is determined in processing block 304. In processing block 306, the assembler outputs the live register information. The live register information can be provided to the user in a user interface, such as the GUI shown in FIG. 6.

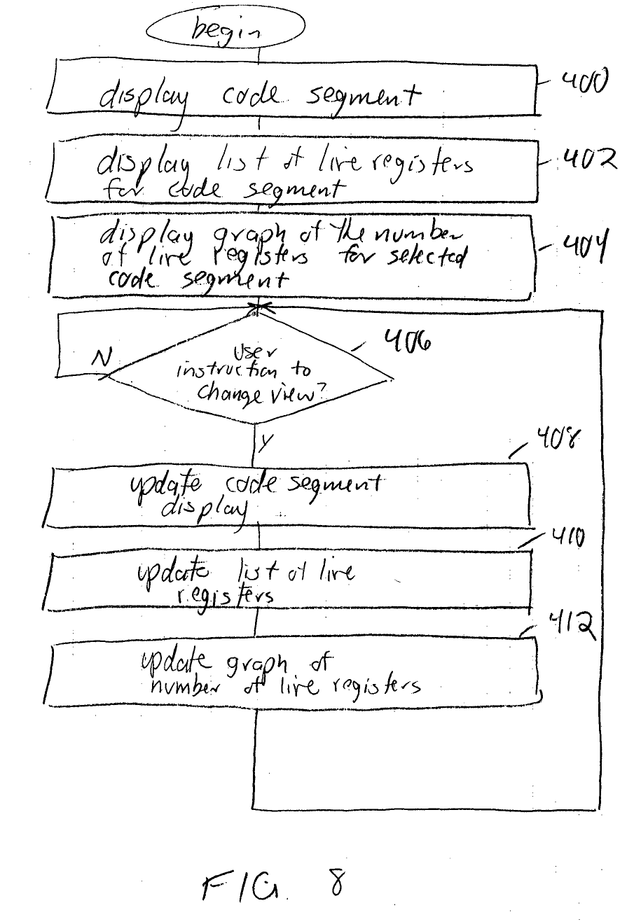

FIG. 8 is flow diagram showing additional details in implementing the GUI of FIG. 6, for example. In processing block 400, a code segment is displayed in a first region of the GUI. In one embodiment, live virtual register information is determined and displayed for each microword. In processing block 402, a list of live virtual registers corresponding to a given microword is displayed in a second region of the GUI and in processing block 404, a graph of the number of live virtual registers versus the microword address is displayed in a third region of the GUI. In one embodiment, the displayed microwords, listed live registers, and graphed live register counts, are synchronized and updated to reflect user selections.

In processing decision block 406, it is determined whether user input has been received to view a different portion of program instructions, listed live registers, or graph area. If not, the system waits for user instructions. If so, based upon the user selection, in processing block 408 the instructions displayed in the first region of the GUI are updated, in processing block 410 the list of live registers is updated, and in processing block 412 the graph of live registers is updated.

Based upon the information provided by the virtual register usage levels, a programmer has a variety of options to deal with excessive register usage. One option for the programmer includes rewriting the code to use fewer registers. The programmer may be able to rearrange the code so that some of the registers cease to be live at the bottleneck, thus reducing the number of physical registers needed at a given time. For example, the program can be modified to re-compute a value rather than using a value computed earlier. Similarly, a calculation can be delayed until just before a result is needed. In addition, if neighbor registers are not being used as a first in/first out (FIFO) device, these registers can become the repository of constants or pseudo-constants (e.g., values computed during startup but which do not change during the main loop). Further, local memory can be used to replace GPRs.

It is also possible that the live-ranges of some registers are not being computed correctly due to incorrect use or lack of use of some of the directives. This would be indicated if a register was listed as live when it really was not. An example of this would be if a register was used, and then in a later section it was conditionally set and then later conditionally used (i.e. “correlated conditionals”). Without an appropriate “set” directive, the register would be considered live from the first set to the last use, when in reality it wasn't “live” between the two sets of references. In this case, the code produced would not be incorrect, but it may use more registers than necessary. Putting in the appropriate “set” directive might reduce the register pressure. Another possibility is that there is an outright bug in the source code, and that by fixing the bug, the number of necessary registers is reduced.

In one embodiment, the assembler generates a flow graph of the program as a mechanism to identify the live range for the virtual registers, and therefore, which registers are live for each microword.

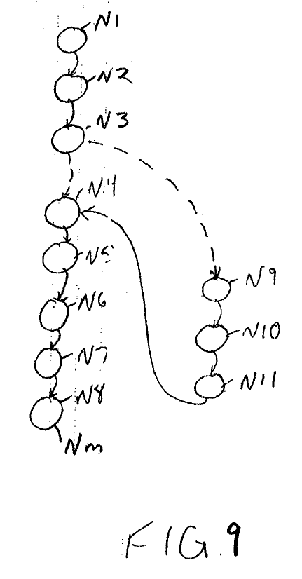

FIG. 9 shows an arbitrary flow graph having a series of nodes N1-Nm each representing program instructions at a given address. Nodes N1-N3 represent consecutive instructions for a code block. At the third node N3, the instruction includes a conditional branch instruction to the fourth node N4 or to the ninth node N9. Nodes N9-N11 can be considered a subroutine. The eleventh node N11 can include a return instruction where a register can provide a return address to the fourth node N4 so that the flow graph jumps to the fourth node N4 and the flow through the fifth node N5 continues.

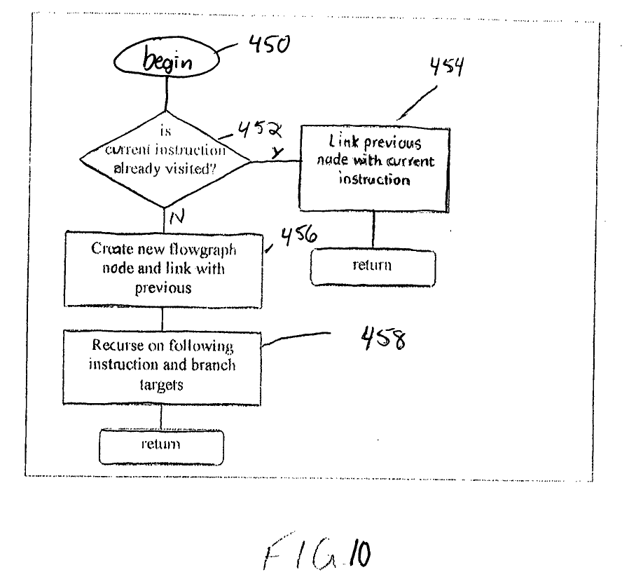

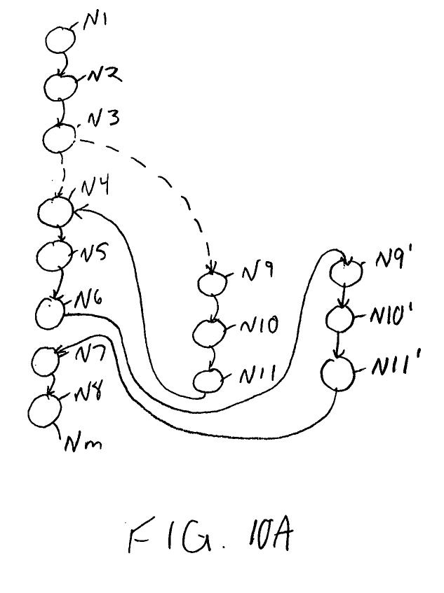

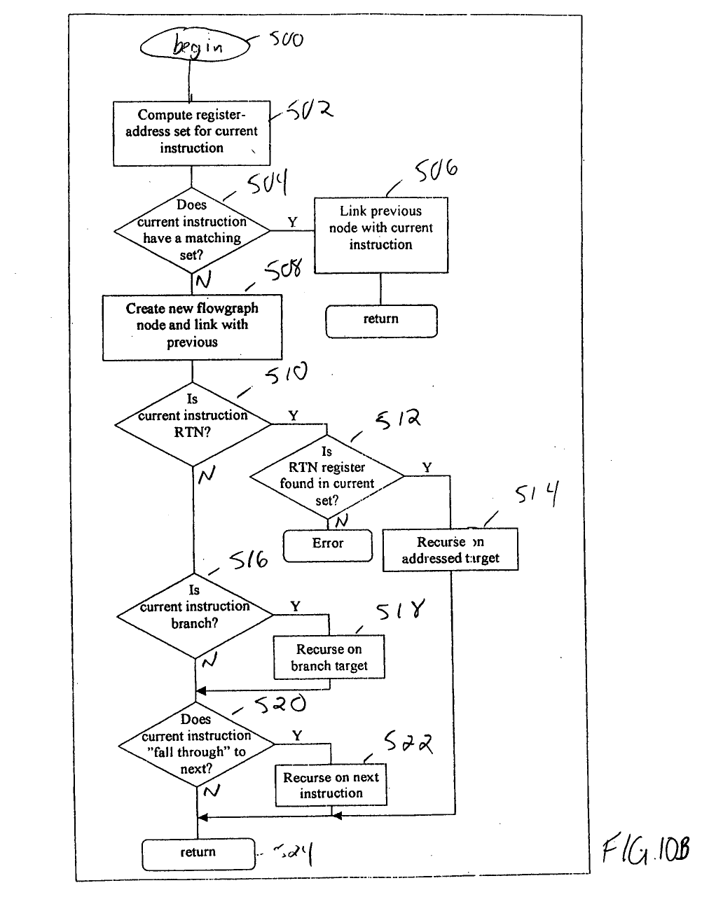

FIG. 10 shows an exemplary implementation of a process to add instructions to a flow graph for an assembler program. The process begins at block 450 and in processing decision block 452, it is determined whether the current instruction has already been visited. If so, the previous node is linked with the current instruction in processing block 454. If not, a new flow graph node is created for the instruction and linked with the previous node in processing block 456.

In processing block 458, the process recurses on the following instruction and branch targets. The process continues until the flow graph for the program is complete.

In this straightforward process, successor instructions are found and recursively linked into the flow graph as successors. For non-branching instructions, the single successor would be the following instruction. For an unconditional branch, the single successor is the branch target. For a conditional branch, there are multiple successors, typically the following instruction and the branch target. Whenever a flow merges in with an already visited instruction, that portion of the recursion returns. When the initial recursion returns, the flow graph is complete.

In the above process, it may not be clear what should occur when a return instruction is reached. This instruction will branch to the instruction whose address is contained in a register. In order to compute the flow graph in such a case, the assembler needs to know the value stored in the register.

The value in the register can originally come from a load address instruction, which stores the value of a label in a register. Each flow graph node has associated with it a set of register-address pairs. Whenever a load address instruction is seen, that register and the associated address are added to the current set of register/address. Whenever an assignment is made to a register, any register-address pair for that register is deleted from the set. When a flow reaches an instruction that has already been visited, the recursion only ends if that instruction has a flow graph node with an identical set. Otherwise, a new flow graph node is constructed for that instruction with the new register-address pair set, and the recursion continues. For example, as shown in FIG. 10A, which has some commonality with FIG. 9 where like reference numbers indicate like elements, there is a subroutine call between the sixth and seventh nodes N6, N7. In this case, the sixth node N6 branches to nodes N9′ and then nodes N10′ and N11′ before branching back to the seventh node N7. Nodes N9 and N9′ are distinct nodes in the flow graph, although both nodes are associated with the same instruction—in this case the first instruction in the subroutine.

FIG. 10B shows further details of a process to add an instruction to a flow graph for a program. In processing block 500, the process begins and in block 502 the register-address set is computed for the current instruction. An exemplary computation of the new register-address set is provided below.
1. Start with set from previous flow graph node (if one exists)
2. If current instruction is a label assignment (e.g. LOAD_ADDR)
   2.1. Delete register-address pairs referencing this instruction's<register>
   2.2. Create new register-address pair.
3. Else if current instruction is a copy and source is different from destination
   3.1. Delete register-address pairs referencing destination register
   3.2. Look up source register in current set, if found create a new register-address pair with the destination register and the address found for the source register
4. Else if register is destination of current instruction
   4.1. Delete register-address pairs referencing destination register

In processing decision block 504, it is determined whether the current instruction has a flow graph node with a matching register-address set. If so, in processing block 506, the previous flow graph node is linked with the current flow graph node. If not, in processing block 508, a new flow graph node is created and linked with the previous node. In decision block 510, it is determined whether the current instruction is a return instruction.

If the current instruction is a return instruction, in processing decision block 512 it is determined whether the RTN register is found in the current instruction register-address set. If not, then there is an error and processing is terminated. If so, then in processing block 514, processing recurses on the addressed target.

If the current instruction was not a return instruction as determined in block 510, then in processing block 516 it is determined whether the current instruction is a branch instruction. If so, then processing recurses on the branch target in processing block 518. If not, in processing decision block 520, it is determined whether the current instruction “falls through” to the next instruction. If so, processing recurses on the next instruction in processing block 522. If not, a return instruction for the process is executed in processing block 524.

Based upon the flow graph and address-register set, the assembler can generally determine which registers are live for each node. The maximum number of live virtual registers at any given flow graph node provides a good approximation of the minimum number of physical registers that must be available in the target hardware. While the maximum number of live registers for any given line is not always equal to the number of physical registers required, it provides a good approximation to the number required. The number of live registers for a given line provides a useful indicator to the programmer as to what portions of their code most contribute to total register usage.

As is known in the art, an assembler processes assembler code, which can be fairly arbitrary. In contrast, a compiler processes a program written in a higher level programming language. Programming languages for compilers typically support well-defined subroutine call/return semantics. That is, when a subroutine calls another subroutine, the compiler knows/specifies where the called-routine will return to without knowing any details of the other subroutine's code. In assembly programming, the programmer is under no such restriction, and thus the assembler needs to determine where the subroutine is going to return by analyzing the subroutine code.

The exemplary methods and systems to provide virtual register use information to a programmer facilitates efficient identification and correction of code requiring more registers than are available. In contrast, when using some conventional assemblers that support virtual registers, a programmer has essentially no help when running out of physical registers. The typical approach for known assemblers is for the programmer to compare the program to an earlier version that assembled or to comment some section of code out and see what happens. These approaches may result in a significant amount of trial-and-error.

In contrast to such conventional assemblers, the exemplary methods and systems described herein can provide a list of live registers at a given instruction address to enable a programmer to understand the details of generated code with respect to register/signal allocations. Providing three synchronized regions (microwords, live register list, and graph) of the GUI enables rapid user navigation. In addition, the graph and list regions can be filtered to show the type of register/signal of interest to the user to avoid excessive clutter. In addition, the same dialog can display the resource utilization for a number of different resources being allocated, such as registers or signals.

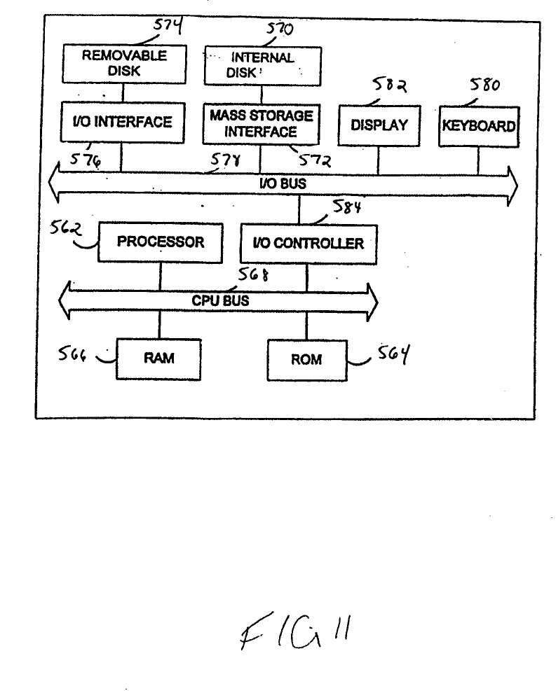

Referring to FIG. 11, an exemplary computer system 560 suitable for use as development/debugger system 102 having an assembler providing live virtual register information. The assembler providing live virtual register information may be implemented in a computer program product tangibly embodied in a machine-readable storage device for execution by a computer processor 562; and methods may be performed by the computer processor 562 executing a program to perform functions of the tool by operating on input data and generating output.

Suitable processors include, by way of example, both general and special purpose microprocessors. Generally, the processor 562 will receive instructions and data from a read-only memory (ROM) 564 and/or a random access memory (RAM) 566 through a CPU bus 568. A computer can generally also receive programs and data from a storage medium such as an internal disk 570 operating through a mass storage interface 372 or a removable disk 574 operating through an I/O interface 576. The flow of data over an I/O bus 578 to and from devices 570, 574, (as well as input device 580, and output device 582) and the processor 562 and memory 566, 564 is controlled by an I/O controller 584. User input is obtained through the input device 580, which can be a keyboard, mouse, stylus, microphone, trackball, touch-sensitive screen, or other input device. These elements will be found in a conventional desktop computer as well as other computers suitable for executing computer programs implementing the methods described here, which may be used in conjunction with output device 582, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks such as internal hard disks 570 and removable disks 574; magneto-optical disks; and CD-ROM disks. Any of the foregoing may be supplemented by, or incorporated in, specially-designed ASICs (application-specific integrated circuits).

Typically, processes reside on the internal disk 574. These processes are executed by the processor 562 in response to a user request to the computer system's operating system in the lower-level software 105 after being loaded into memory. Any files or records produced by these processes may be retrieved from a mass storage device such as the internal disk 570 or other local memory, such as RAM 566 or ROM 564.

The system 102 illustrates a system configuration in which the application software 104 is installed on a single stand-alone or networked computer system for local user access. In an alternative configuration, e.g., the software or portions of the software may be installed on a file server to which the system 102 is connected by a network, and the user of the system accesses the software over the network.

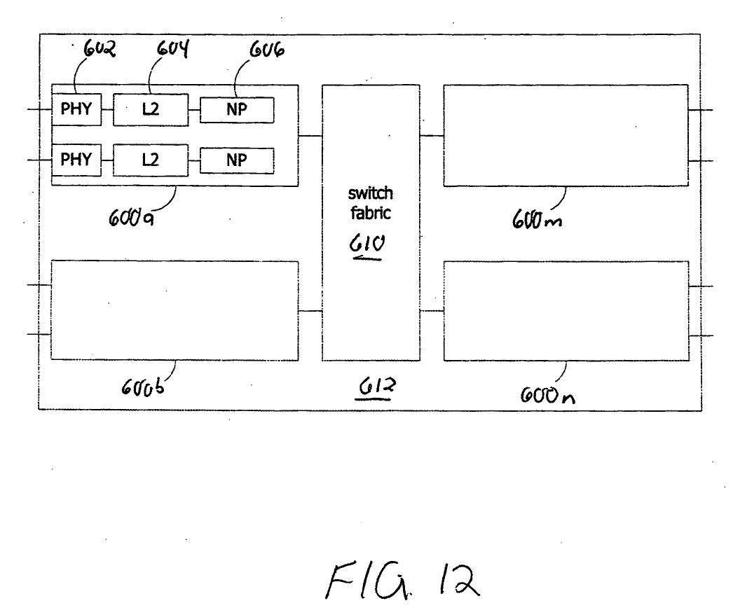

FIG. 12 depicts a network forwarding device that can include a network processor having microcode produced by an assembler providing virtual register usage information. As shown, the device features a collection of line cards 600 (“blades”) interconnected by a switch fabric 610 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 600a) may include one or more physical layer (PHY) devices 602 (e.g., optic, wire, and wireless PHYs) that handle communication over network connections. The PHYs translate between the physical signals carried by different network mediums and the bits (e.g., “0”-s and “1”-s) used by digital systems. The line cards 600 may also include framer devices (e.g., Ethernet, Synchronous Optic Network (SONET), High-Level Data Link (HDLC) framers or other “layer 2” devices) 604 that can perform operations on frames such as error detection and/or correction. The line cards 600 shown may also include one or more network processors 606 that perform packet processing operations for packets received via the PHY(s) 602 and direct the packets, via the switch fabric 610, to a line card providing an egress interface to forward the packet. Potentially, the network processor(s) 606 may perform “layer 2” duties instead of the framer devices 604.

While FIGS. 1, 2, 3 and 12 describe specific examples of a network processor and a device incorporating network processors, the techniques described herein may be implemented in a variety of circuitry and architectures including network processors and network devices having designs other than those shown. Additionally, the techniques may be used in a wide variety of network devices (e.g., a router, switch, bridge, hub, traffic generator, and so forth).

The term circuitry as used herein includes hardwired circuitry, digital circuitry, analog circuitry, programmable circuitry, and so forth. The programmable circuitry may operate on computer programs.

Further features and advantages of the above-described embodiments will be readily apparent to one of ordinary skill in the art. Accordingly, the illustrative embodiments are not to be limited by what has been particularly shown and described herein, except as indicated by the appended claims.

1. A method to provide virtual resource usage information, comprising:
processing an assembler code program that references virtual resources;
determining live ranges for the virtual resources for at least portions of the program; and
providing live virtual resource information for the program portions.

2. The method according to claim 1, wherein the live virtual resource information includes at least one of virtual signal information and virtual register information.

3. The method according to claim 2, further including providing the live virtual resource information as an output file.

4. The method according to claim 3, further including providing the output file having a number of live registers for each instruction address.

5. The method according to claim 4, further including providing the output file having a number of live registers for various types of virtual registers.

6. The method according to claim 1, further including providing the live virtual resource information as part of a graphical user interface.

7. The method according to claim 6, wherein the graphical user interface includes a region to display program instructions.

8. The method according to claim 7, wherein the region includes a number of live virtual resources for the program instructions.

9. The method according to claim 8, wherein the live virtual resources include at least one of virtual registers and virtual signals.

10. The method according to claim 8, wherein the graphical user interface further includes a region to display a list of live virtual resources at a given location in instruction memory.

11. The method according to claim 8, wherein the graphical user interface further includes a region to display a graph of live virtual resource usage.

12. The method according to claim 8, wherein the graphical user interface further includes one or more of a first region to display program instructions, a second region to display a list of live virtual resources, and a third region to display a graph of virtual resource usage.

13. The method according to claim 12, wherein displayed program instruction, listed live virtual resources, and graphed virtual resource usage correspond to a selected program instruction.

14. The method according to claim 12, wherein displayed program instructions, listed live virtual resources and graphed virtual resource usage are updated in response to user input.

15. The method according to claim 13, wherein displayed program instructions, listed live virtual resources and graphed virtual resource usage are synchronized.

16. The method according to claim 12, wherein the first region includes program instruction addresses and/or a number of live virtual resources for at least some of the program instructions.

17. The method according to claim 12, wherein the third region includes a graph of number of live virtual resources versus program instructions addresses.

18. An article, comprising:
a storage medium having stored thereon instructions that when executed by a machine result in the following:
processing an assembler code program that references virtual resources;
determining live ranges for the virtual resources for at least portions of the program; and
providing live virtual resource information for the program portions.

19. The article according to claim 18, wherein the live virtual resource information includes at least one of virtual signal information and virtual register information.

20. The article according to claim 16, further including instructions to provide the live virtual resource information as an output file.

21. The article according to claim 17, further including instructions to provide the output file having a number of live resources for each instruction address of the program.

22. The article according to claim 16, further including instructions to provide the live virtual resource information as part of a graphical user interface.

23. The article according to claim 22, wherein the live resources include at least one of virtual registers and virtual signals.

24. The article according to claim 22, further including instructions to generate the graphical user interface to include one or more of a first region to display program instructions, a second region to display a list of live virtual resources, and a third region to display a graph of virtual resource usage.

25. The article according to claim 24, further including instructions to provide that any displayed program instruction, listed live virtual resources, and graphed virtual resource usage correspond to a selected program instruction.

26. The article according to claim 25, further including instructions to provide that any displayed program instructions, listed live virtual resources and graphed virtual resource usage are synchronized.

27. A development/debugger system, comprising:
an assembler to generate microcode that is executable in a processing element by
processing an assembler code program that references virtual resources;
determining live ranges for the virtual resources for at least portions of the program; and
providing live virtual resource information for the program portions.

28. The system according to claim 27, wherein the virtual resources include at least one of virtual registers and virtual signals.

29. The system according to claim 27, further including providing the live virtual resource information as an output file.

30. The system according to claim 27, further including providing the output file having a number of live resources for each instruction address.

31. The system according to claim 27, further including providing the live virtual resource information as part of a graphical user interface.

32. The system according to claim 31, wherein the graphical user interface further includes one or more of a first region to display program instructions, a second region to display a list of live virtual resources, and a third region to display a graph of virtual resource usage.

33. The system according to claim 32, wherein any of the displayed program instruction, the listed live virtual resources, and the graphed virtual resource usage correspond to a selected program instruction.

34. A network forwarding device, comprising:
at least one line card to forward data to ports of a switching fabric;
the at least one line card including a network processor having multi-threaded microengines configured to execute microcode, wherein the microcode comprises a microcode developed using an assembler that
processed an assembler code program that references virtual resources;
determined live ranges for the virtual resources for at least portions of the program; and
provided live resource information for the program portions.

35. The device according to claim 34, wherein the virtual resources include at least one of virtual registers and virtual signals.

36. The device according to claim 34, wherein the assembler provided the live virtual resource information as an output file.

37. The device according to claim 34, wherein the assembler provided the live virtual resource information as part of a graphical user interface.

38. The device according to claim 37, wherein the graphical user interface included one or more of a first region to display program instructions, a second region to display a list of live virtual resources, and a third region to display a graph of virtual resource usage.
